(19) United States
(12) Patent Application Publication
(10) Pub. No.: US 2008/0088750 A1
(43) Pub. Date: Apr. 17, 2008

(54) Display Device with Speaker Grill

(76) Inventors: Michael Cadio, Carmel, IN (US); William Hofmann Bose, Indianapolis, IN (US)

Correspondence Address: FLETCHER YODER P.C., 7915 FM 1960 RD. WEST, SUITE 330, HOUSTON, TX, 77070, US

(21) Appl. No.: 11/793,341

(22) PCT Filed: Dec. 29, 2005
(86) PCT No.: PCT/US05/47554

§ 371 Date: Jun. 18, 2007

Related U.S. Application Data
(60) Provisional application No. 60/641,825, filed on Jan. 5, 2005.

(51) Int. Cl. H04N 5/64; H04N 5/74

(52) U.S. Cl. 348/836; 381/391

(57) ABSTRACT

The disclosed embodiments relate to a display device with a speaker grill. More specifically, there is provided a display device (10) comprising a display screen (16), a frame (14) disposed around the display screen (16), and a speaker grill (18) coupled to the frame (14) and the display screen (16), wherein the display screen (16) is lodged between a support bracket (22) of the speaker grill (18) and an edge portion (23) of the speaker grill (18).

### CROSS-REFERENCE TO RELATED APPLICATIONS

This application claims priority to provisional U.S. Application No. 60/641,825 filed on Jan. 5, 2005.

### FIELD OF THE INVENTION

The present invention relates generally to video and audio systems. More specifically, the present invention relates to a display device with an improved speaker grill.

### BACKGROUND OF THE INVENTION

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Display devices such as televisions and computer monitors may incorporate speakers. Accordingly, such devices may incorporate speaker grills. Some display devices may comprise a metal frame in which plastic speaker grills are mounted. Alignment of the speaker grills with the frame may be desirable to achieve specific design goals related to the appearance of the display device. A cost effective manner of mounting a speaker grill on a display device is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a display device with a speaker grill. More specifically, there is provided a display device comprising a display screen, a frame disposed around the display screen, and a speaker grill coupled to the frame and the display screen, wherein the display screen is lodged between a support bracket of the speaker grill and an edge portion of the speaker grill.

### BRIEF DESCRIPTION OF THE DRAWINGS

Advantages of the invention may become apparent upon reading the following detailed description and upon reference to the drawings in which:

FIG. 1 is a perspective view of a display device in accordance with one embodiment of the present invention;

FIG. 2 is a front view of a display device in accordance with one embodiment of the present invention;

FIG. 3 is an exploded view of a speaker grill assembly in accordance with one embodiment of the present invention;

FIG. 4 is a perspective view of a speaker grill assembly in accordance with one embodiment of the present invention;

FIG. 5 is another perspective view of a speaker grill assembly in accordance with one embodiment of the present invention;

FIG. 6 is a cross-sectional view taken along lines 6-6 of FIG. 5; and

FIG. 7 is a speaker grill in accordance with one embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

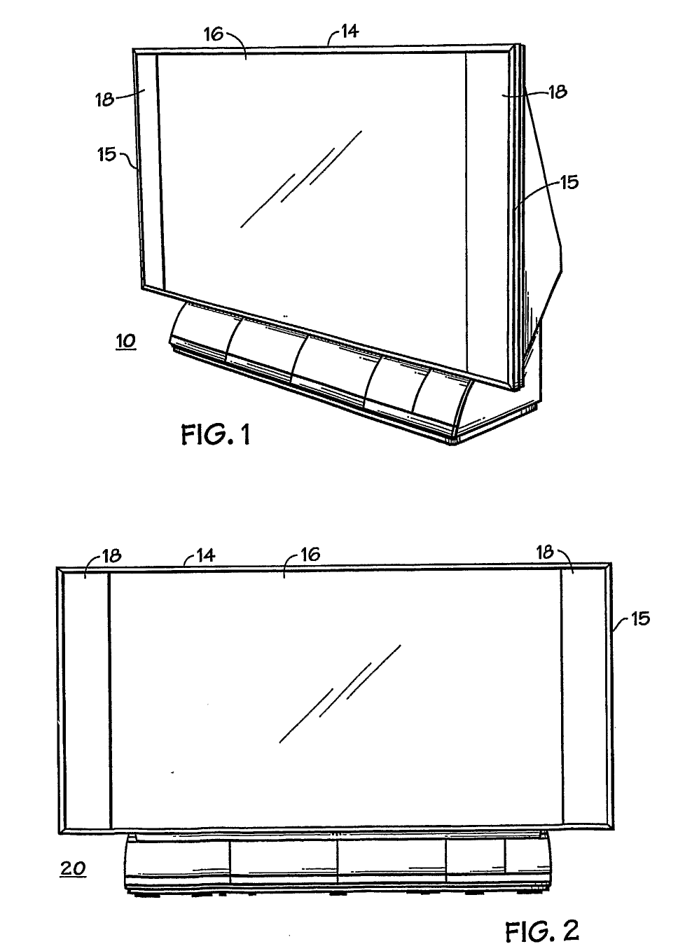

FIG. 1 is a perspective view of a display device in accordance with one embodiment of the present invention. The display device is generally referred to by a reference numeral 10. The display device 10 comprises two speaker grills 18, which cover separate speakers (not shown). While two speaker grills 18 are shown in FIG. 1, those of ordinary skill in the art will appreciate that any number of speaker grills may be employed in embodiments of the invention. In the embodiment shown in FIG. 1, the two speaker grills 18 are disposed on each side of the display device 10. The display device 10 includes a display screen 16. A frame 14, which may comprise metal such as aluminum, is disposed around the display screen 16 and the speaker grills 18. A frame side member 15 is disposed adjacent to each of the speaker grills 18.

FIG. 2 is a front view of a display device in accordance with one embodiment of the present invention. The display device is generally indicated by the reference numeral 20. The display device 20 may comprise any type of display device known to those of ordinary skill in the art. Exemplary display devices include a television (such as a Digital Light Processing System (DLP)), a flat panel display (such as a plasma screen or an LCD panel), a computer monitor, or the like.

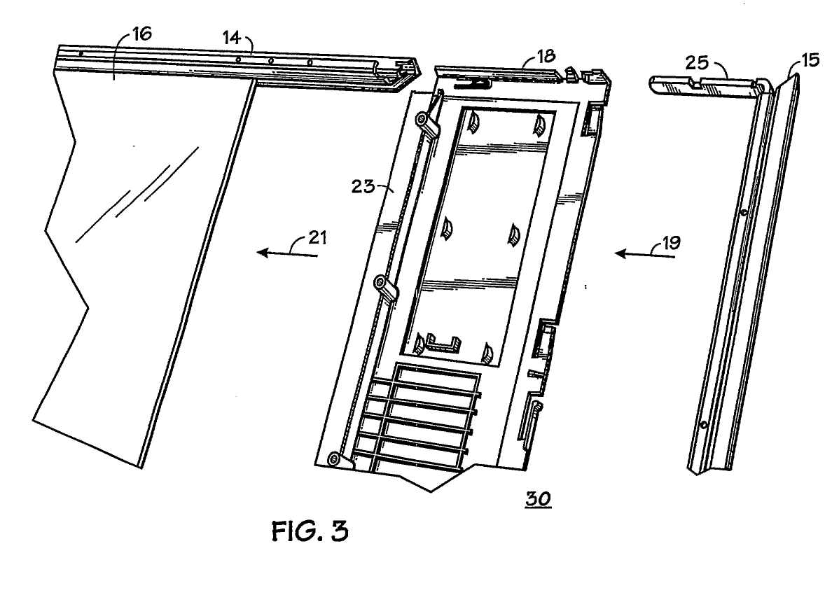

FIG. 3 is an exploded view of a speaker grill assembly in accordance with one embodiment of the present invention. The speaker grill assembly is generally referred to by the reference numeral 30. A speaker grill 18, which may comprise plastic, is disposed for slidable engagement with the frame 14. An end assembly 25 is disposed for slidable engagement with the speaker grill and the frame 14. One frame side member 15 is coupled to the end assembly 25 so that the frame side member 15 abuts the frame 14 when the end assembly 25 is engaged therein. The end assembly 25 is adapted to engage the speaker grill 18 via slidable motion as indicated by an arrow 19. The speaker grill 18 is adapted to engage the frame 14 via slidable motion as indicated by an arrow 21. The speaker grill 18 comprises an edge portion 23, which is adapted to overlap the display screen 16, as will be fully described below.

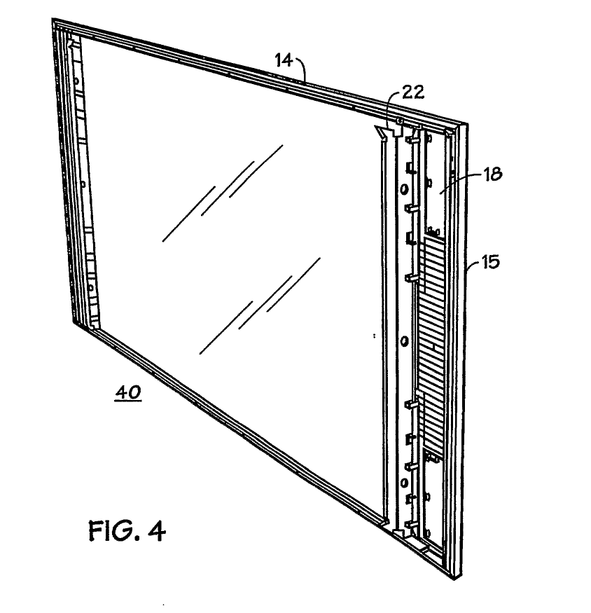

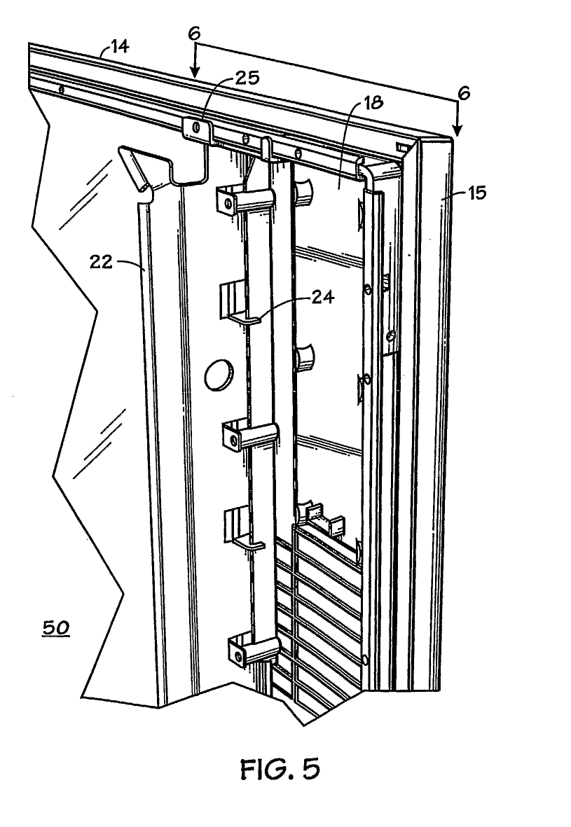

FIG. 4 is a perspective view of a speaker grill assembly in accordance with one embodiment of the present invention. The speaker grill assembly is generally referred to by a reference numeral 40. The speaker grill assembly 40 comprises a grill support bracket 22. Additional details regarding the grill support bracket 22 are shown below with reference to FIG. 5.

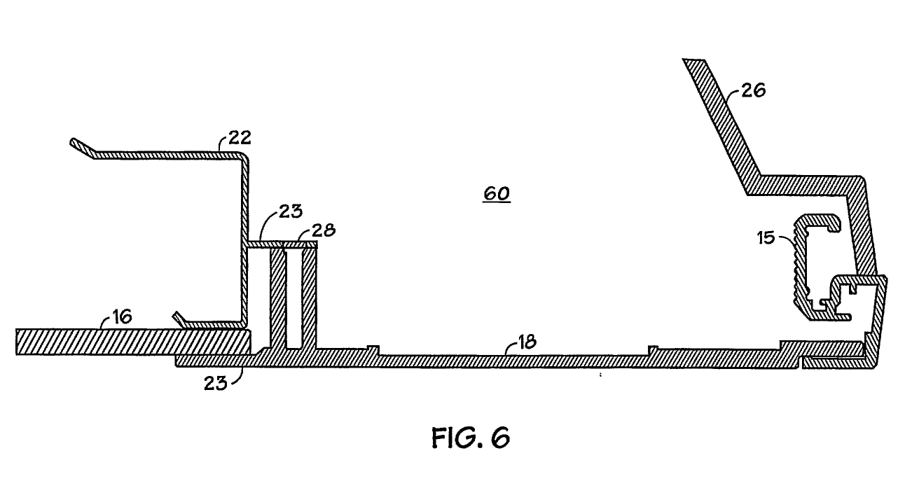

FIG. 5 is another perspective view of a speaker grill assembly in accordance with one embodiment of the present invention. The speaker grill assembly is generally referred to by a reference numeral 50. When assembled, the speaker grill 18 is engaged and secured by the frame 14 and the frame side member 15. The speaker grill 18 is attached to the grill support bracket 22. The grill support bracket 22 may be secured to the frame 14 via a fastening mechanism 25, such as a screw or the like. The grill support bracket 22 may include a horizontal centering member 24. The horizontal centering member 24 provides for horizontal centering of the grill support bracket 22 with respect to the speaker grill 18. As shown in FIG. 6, the grill support bracket 22 acts to support the display screen 16 in position. FIG. 5 also includes the lines G-6 that illustrate a cross-sectional area further illustrated in FIG. 6.

FIG. 6 is a cross-sectional view taken along lines 6-6 of FIG. 5. The speaker grill assembly is generally referred to with the reference numeral 60. As shown in FIG. 6, the display screen 16 is sandwiched between the grill support bracket 22 and the edge portion 23 of the speaker grill 18. In other words, the display screen 16 is lodged or disposed between the support bracket 22 and the edge portion 23. In one embodiment, the display screen 16 is lodged in a guide slot or channel formed by a cantilevered support bracket 22 and a cantilevered edge portion 23. In alternate embodiments, the support bracket 223 and the edge portion 23 may be partially or fully recessed with the speaker grill 18. The securing mechanism 23 of the grill support bracket 22 is secured to the speaker grill 18 by a screw 28. Those of ordinary skill in the art will appreciate that other appropriate devices may be employed to secure the grill support bracket 22 to the speaker grill 18.

The other end of the speaker grill 18 is secured by the frame side member 15. The frame side member 15 abuts a cabinet 26 of the display device 10 (See FIG. 1).

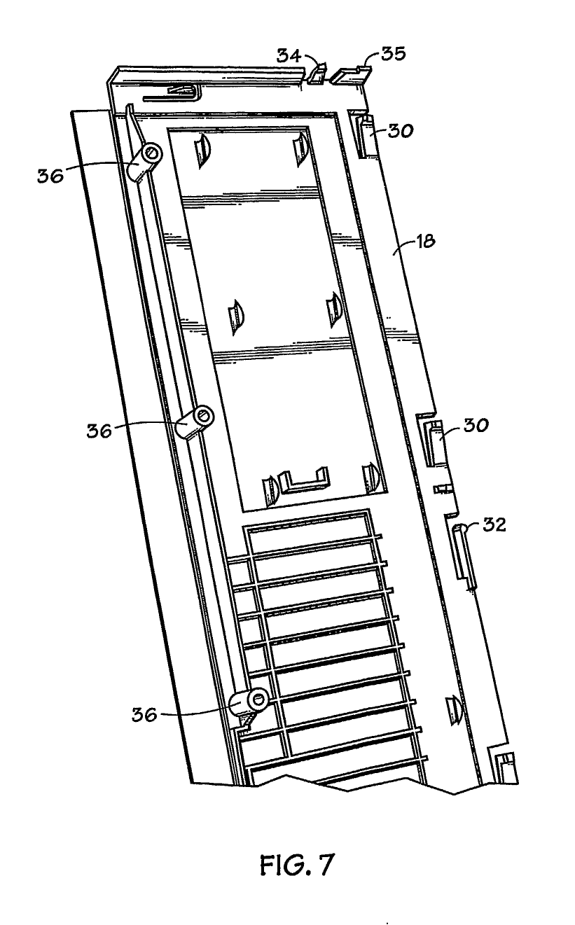

FIG. 7 is a speaker grill in accordance with one embodiment of the present invention. The speaker grill 18 comprises a biasing portion or “preload” 30, which is adapted to bias the speaker grill 18 towards the front of the frame 14. Two biasing portions 30 are illustrated in FIG. 7; however, those of ordinary skill in the art will readily recognize that fewer or more biasing portions 30 may be employed. A biasing portion or “preload” 32 is adapted to bias the speaker grill 18 towards the center of the display screen 16. The speaker grill 18 further comprises a biasing portion or “preload” 34 which operates to center the speaker grill 18.

The speaker grill 18 comprises a registration member 35. The registration member 35 acts to register the speaker grill 18 with respect to the metal frame 14. The speaker grill 18 may also include one or more bosses 36. The bosses 36 provide support for attachment of the speaker grill 18 to the grill support bracket 22 (See FIG. 5).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A display device comprising:
a display screen;
a frame disposed around the display screen; and
a speaker grill coupled to the frame and the display screen, wherein the display screen is lodged between a support bracket of the speaker grill and an edge portion of the speaker grill.

2. The display device of claim 1, wherein the support bracket and the edge portion form a cantilevered channel for the display screen.

3. The display device of claim 1, wherein the support bracket and the edge portion are recessed within the speaker grill.

4. The display device of claim 1, wherein the speaker grill comprises a biasing portion adapted to bias the speaker grill towards a front side of the frame.

5. The display device of claim 1, wherein the speaker grill comprises a biasing portion adapted to bias the speaker grill towards the center of the display screen.

6. The display device of claim 1, wherein the speaker grill comprises a registration member adapted to register the screen grill with respect to the metal frame.

7. The display device of claim 1, wherein the speaker grill comprises a boss adapted to support attachment of the speaker grill to a grill support bracket.

8. The display device of claim 1, wherein display device comprises a digital light processing television.

9. The display device of claim 1, comprising another speaker grill disposed on the opposite side of the display screen, wherein the another speaker grill is coupled to the frame and the display screen, wherein the display screen is lodged between a support bracket of the another speaker grill and an edge portion of the another speaker grill.

10. The display device of claim 1, comprising a speaker mounted behind the speaker grill.

11. A method of manufacturing a display device, the method comprising:
attaching a display screen to a frame; and
attaching a speaker grill to the display screen and the frame such that the display screen is lodged between a support bracket of the speaker grill and an edge portion of the speaker grill.

12. The method of claim 11, comprising:
attaching an end assembly to the speaker grill and the frame.

13. The method of claim 11, wherein attaching the speaker grill comprises sliding the speaker grill through the frame until the display screen is lodged between the support bracket of the speaker grill and the edge portion of the speaker grill.

14. The method of claim 13, wherein step attaching the speaker grill comprises sliding the speaker grill through the frame until the display screen is lodged between a cantilevered support bracket and a cantilevered edge portion.

15. The method of claim 11, comprising:
registering the speaker grill with respect to the frame using a registration member.

16. The method of claim 11, comprising:
attaching the speaker grill to a grill support bracket using a boss.

17. The method of claim 11, wherein the steps are performed in the recited order.

18. A display device comprising:
a display screen;
a frame disposed around the display screen; and
a speaker grill coupled to the frame and the display screen, wherein the display screen is lodged within a channel associated with the speaker grill (18).

19. The display device (10) of claim 18, wherein the display screen is lodged within a channel protruding from the speaker grill.

20. The display device of claim 18, comprising an end assembly coupled to the speaker grill and the frame.
